(19) United States
(12) Patent Application Publication
(10) Pub. No.: US 2022/0292374 A1
(43) Pub. Date: Sep. 15, 2022

(54) DYNAMIC PARAMETER COLLECTION TUNING

(71) Applicant: ServiceNow, Inc., Santa Clara, CA (US)

(72) Inventor: Ashton Mozano, San Diego, CA (US)

(21) Appl. No.: 17/201,936

(22) Filed: Mar. 15, 2021

(51) Int. Cl. G06N 5/04; G06N 20/00

(52) U.S. Cl. CPC G06N 5/04; G06N 20/00; H04L 67/10

(57) ABSTRACT

Collected data of a first set of parameters is received via a network from one or more devices. Using machine learning, at least a portion of the collected data of the first set of parameters is analyzed to automatically identify one or more additional data parameters to be obtained to verify a detection of an incident pattern. The one or more additional data parameters are indicated to be obtained to at least a portion of the one or more devices. Collected data responsive to the indicated one or more additional data parameters is received. Based at least in part on the responsive collected data, the detection of the incident pattern is verified and a responsive action is performed.

### BACKGROUND OF THE INVENTION

Information technology infrastructure including network-based architectures are used to provide computing services including both cloud-based services and localized network services. The provided functionality can be complex and feature-rich and may cover a range of applications such as file sharing, email, user identification, network security, account verification, web hosting, messages, and data stores, among others. Typically, the different functionality is provided by a variety of different hardware and software components that are interconnected. Each component can serve one or more purposes and individually and/or collectively can require management, configuration, and maintenance.

### BRIEF DESCRIPTION OF THE DRAWINGS

Various embodiments of the invention are disclosed in the following detailed description and the accompanying drawings.

FIG. 1 is a block diagram illustrating an example of an adaptive and dynamic monitoring platform for automatically identifying incidents.

FIG. 2 is a flow chart illustrating an embodiment of a process for automatically identifying incidents using dynamic parameter collection tuning.

FIG. 3 is a flow chart illustrating an embodiment of a process for collecting sensor device data for automatically identifying incidents.

FIG. 4 is a flow chart illustrating an embodiment of a process for analyzing collected sensor device data.

FIG. 5 is a flow chart illustrating an embodiment of a process for utilizing a machine learning incident model for identifying incidents.

FIG. 6 is a flow chart illustrating an embodiment of a process for preparing a machine learning incident model for identifying incident patterns.

FIG. 7 is a flow chart illustrating an embodiment of a process for adapting sensor data collection for automatically identifying incidents.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Dynamic parameter tuning for automatically identifying incidents is disclosed. Using the disclosed techniques, incidents such as security breaches and future hardware and/or software failures can be predicted and/or detected. In response to identifying an incident, preventative actions, such as closing and addressing a security breach or preemptively replacing hardware prior to failure, can be implemented. In various embodiments, agents and/or sensors are distributed across the information technology infrastructure to monitor devices and/or processes. Data parameters are collected by the sensors and analyzed by an adaptive and dynamic monitoring platform. For example, data parameters such as CPU, RAM, and IO operations are logged and collected from distributed tunable sensors. Additional data parameters such as application and database connectivity and utilization can also be collected. The collected data is aggregated and analyzed by a monitoring platform to detect potential incidents. The potential incidents can be detected based on recognized incident patterns. In some embodiments, the potential incidents are detected by applying a trained machine learning model to infer potential incidents using the processed collected data as input features.

Once a potential incident is detected, the sensors can be dynamically tuned to capture only relevant data required to confirm the potential incident. For example, some sensors can be deactivated or their logging abilities reduced while others are tuned to focus on collecting particular data parameters at a higher granularity, frequency, or using an otherwise revised schedule. By redirecting the sensors to focus on collecting only the data parameters required for confirming the incident, the monitoring platform can dynamically adjust to collect only essential data parameters without dedicating valuable resources to collecting and analyzing non-essential data. Once sufficient additional data is collected, the monitoring platform can verify the existence of an incident, such as security vulnerability, a predicted future security breach, a predicted future system failure, or another predicted incident. In response to a verified incident, the monitoring platform can initiate and perform a responsive action. For example, when the onset of a security attack is identified, a targeted range of access privileges can be revoked and certain network ports and/or access can be disabled to prevent a potential security breach. As another example, when a future approaching disk storage failure is identified, hardware disk drives can be preemptively replaced.

The advantages of the disclosed adaptive and dynamic monitoring platform are significant and the benefits include improved service availability, improved performance, improved reliability, improved security, reduced maintenance, and reduced servicing costs, among others. For example, by replacing the hardware such as hardware disk drives preemptively, future downtime and potential data loss are avoided. The cost and time savings of performing maintenance preventively instead of routinely can be significant. For example, instead of replacing a specific hardware device on a recommended routine schedule, such as every six months, the device can be replaced only when a future failure is approaching. While this can result in replacing the device after the recommended six months, it can also result in replacing the device after a different length of use such as after an extended usage time of two years or a shortened life of only three months. Since each replacement is preventative and based on an identified impending failure, each replacement is not only necessary to avoid a device failing but also maximizes the useful life of the device while avoiding the more significant and costly consequences of an unexpected failure when compared to a scheduled replacement.

In some embodiments, collected data of a first set of parameters from one or more devices is received via a network. For example, data is logged and collected by one or more sensor agents distributed at different hardware devices and/or network locations. The sensors can collect performance metrics such as network addresses associated with login attempts, file access attempts, memory usage, disk usage, and the types, amounts, and frequency of inter-process communication, among other data parameters. At least a portion of the collected data of the first set of parameters is analyzed to automatically identify one or more additional data parameters to be obtained to verify a detection of an incident pattern. In some embodiments, the one or more additional data parameters are automatically identified by using machine learning. For example, a machine learning model is applied to infer and detect an incident pattern and the required data parameters to verify the incident. Once a potential incident has been identified, the data collection can be refined to focus on the most relevant and essential data parameters. Non-essential data collection can be deprioritized. The one or more additional data parameters to be obtained are indicated to at least a portion of the one or more devices. For example, sensor devices that are associated with the essential data parameters are provided with revised detection directives. The updated directives can describe a new target set of detection data parameters and new capture rules for collecting the data. In various embodiments, collected data responsive to the indicated one or more additional data parameters is received. Once received, the collected data can be aggregated and analyzed. Based at least in part on the responsive collected data, the detected incident pattern is verified, and a responsive action is performed. For example, in the event the newly collected data confirms the detected incident, preventative actions can be performed to mitigate the impact and consequences of the incident. However, in the event the newly collected data confirms the potential incident was not detected, platform monitoring can be further revised, for example, by redirecting the sensor devices to utilize their original or another modified set of data collection directives.

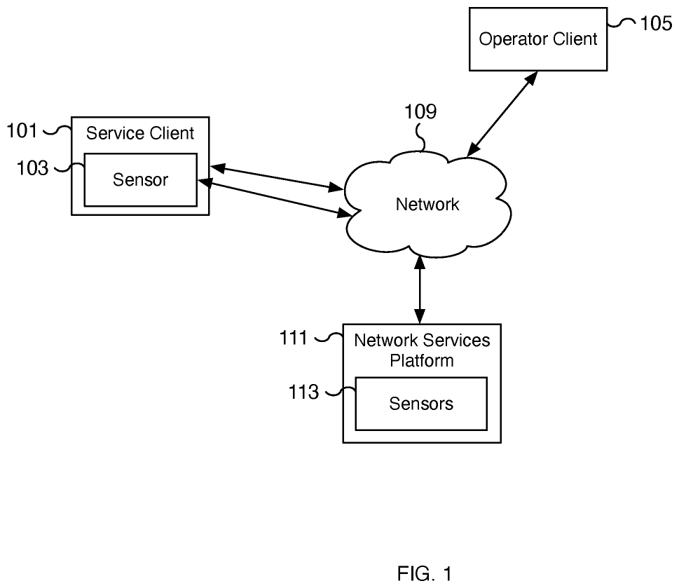

FIG. 1 is a block diagram illustrating an example of an adaptive and dynamic monitoring platform for automatically identifying incidents. Example incidents can include potential security vulnerabilities, potential or ongoing security attacks, pending security breaches, and pending system or component failures, among others. In the example shown, incidents can be identified in an information technology architecture that includes network services platform 111 and clients for accessing network services platform 111 such as service client 101 and operator client 105 via network 109. Network 109 can be a public or private network. In some embodiments, network 109 is a public network such as the Internet. In addition to hosting network application services, network services platform 111 is also an adaptive and dynamic monitoring platform and includes functionality for automatically identifying incidents by dynamically adjusting collected data parameters from distributed sensor devices such as sensor 103 and sensors 113. In the example shown, network services platform 111 can be managed from an operator client such as operator client 105. For example, an operator can monitor automatically identified incidents detected by the adaptive and dynamic monitoring platform of network services platform 111 via operator client 105.

In some embodiments, network services platform 111 includes one or more components (not individually shown) including cloud servers, application nodes, security servers, authentication servers, load balancers, proxies, and database servers, among others for providing network services to clients such as service client 101 and operator client 105. Example network application services offered by network services platform 111 can include email, web services, account services, file sharing services, messaging services, database hosting, and/or IT management services, among others. In the example shown, network services platform 111 includes sensors 113. Sensors 113 are one or more sensor devices (or sensor agents) that are distributed throughout network services platform 111 for collecting data such as performance and operating metrics. The different sensor devices of sensors 113 can be installed on or alongside the different components of network services platform 111. In some embodiments, the sensors are software sensor processes that run on one or more hardware or software components of network services platform 111 but may also include hardware sensor devices for monitoring process and hardware activity.

In various embodiments, sensor 103 and sensors 113 are adaptive sensor devices. They can be configured to target the collection of specific data parameters dynamically. This allows them to modify what type of data is collected and how often the data is collected. In some embodiments, sensor 103 and sensors 113 also include a capture rule engine and can be installed with and process capture rules. The configured capture rules allow a sensor device to determine how to capture particular data parameters. For example, a sensor device of sensor 103 or sensors 113 can be configured to capture and log the source location of all incoming network connections when the traffic rate exceeds a configured threshold value. As another example, a disk monitoring sensor of sensor 103 or sensors 113 can be configured to collect and log disk access requests when the hardware disk capacity exceeds a configured threshold value (for example, triggered when less than 5% of total storage is available) or when the hardware disk capacity fluctuates significantly (for example, the number of writes over a period of an hour exceeds the average rate of writes by 30%). In various embodiments, different capture rules can be configured and installed on different sensor devices to allow each sensor to customize its capture behavior. In the example shown, sensor 103 is installed on a remote client external to the local network of network services platform 111 (shown separated from network services platform 111 by network 109). In contrast, sensors 113 are installed within the network infrastructure of network services platform 111. The addition of sensor 103 on service client 101 allows the operation of a client to be monitored for the detection of particular incidents and vulnerabilities.

Although single instances of some components have been shown to simplify the diagram, additional instances of any of the components shown in FIG. 1 may exist. For example, network services platform 111 typically includes multiple components including multiple server instances and database servers that are communicatively connected. In some embodiments, network services platform 111 is a network accessible service such as a cloud service and may be replicated or distributed across multiple network locations and/or datacenters. As another example, service client 101 and operator client 105 are just two examples of potential clients for accessing network services platform 111. Fewer or more clients can connect to network services platform 111. In some embodiments, components not shown in FIG. 1 may also exist.

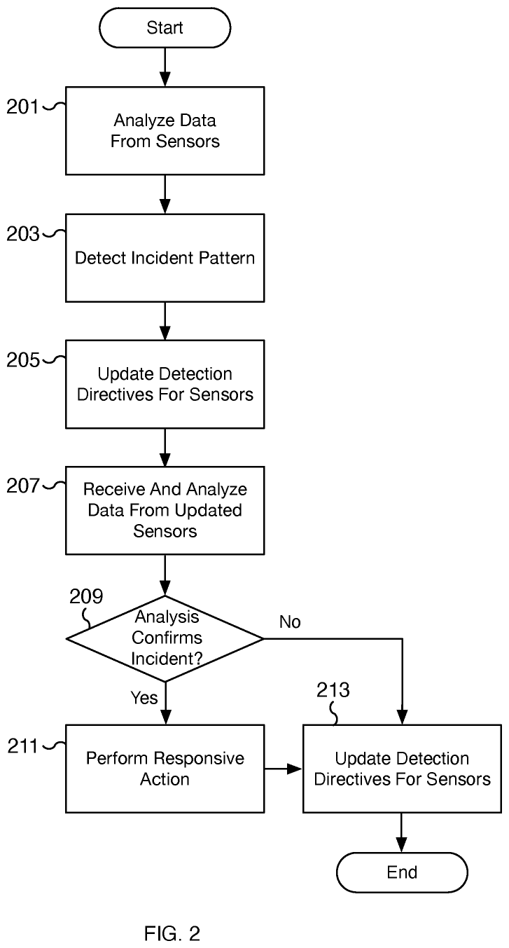

FIG. 2 is a flow chart illustrating an embodiment of a process for automatically identifying incidents using dynamic parameter collection tuning. Using the process of FIG. 2, an information technology infrastructure is monitored using sensor devices to collect data parameters associated with the information technology infrastructure for analysis. When an incident pattern is detected, the monitoring system adjusts the sensor devices to revise their detection directives to focus on collecting the essential data parameters required for verifying the detected incident. In some embodiments, the process of FIG. 2 is performed by an adaptive and dynamic monitoring platform such as the monitoring system of network services platform 111 of FIG. 1. In various embodiments, the sensor devices used to collect data parameters include sensor devices such as sensor 103 and sensors 113 of FIG. 1. The monitored information technology infrastructure can include the network infrastructure associated with the services offered as well as clients used to access the services.

At 201, data from sensors is analyzed. For example, data collected or logged from distributed sensor devices is received by an analysis component of an adaptive and dynamic monitoring platform. The analysis component may be a specialized software and/or hardware process running on a computer processing server such as a cloud server that is part of the monitoring platform. In various embodiments, as part of the analysis, the sensor devices are programmed with appropriate detection directives such as what data parameters to collect and when to collect them. As the monitored data is received, it is processed and analyzed. In some embodiments, the processing includes one or more pre-processing steps such as merging the different collected data sets, reconciling any discrepancies between different collected data, and aggregating the data. In some embodiments, the data is analyzed by applying machine learning to identify incident patterns.

At 203, an incident pattern is detected. For example, an incident pattern associated with an incident such as a security vulnerability or a pending failure is detected. The incident pattern can be detected by identifying input features from the data analyzed at 201 and inferring prediction results using a trained machine learning model. For example, changes or deviations in certain monitored data parameters may be associated with an incident pattern that can be detected by closely monitoring the behavior of the information technology infrastructure system with distributed sensor devices. In many scenarios, a detected incident pattern indicates that the associated incident may be likely to occur. For example, the detected incident pattern can be a predictive indicator of an event such as a security violation or a pending hardware and/or software failure. Additional analysis including gathering additional data may be necessary to confirm the incident before a responsive action is taken.

At 205, detection directives are updated for sensors. Once an incident is detected, the required additional data parameters and associated data to confirm the incident are determined. These additional parameters form a detection directive that is used to update the appropriate sensor devices. The new detection directive may reduce or even eliminate the monitoring of non-essential data parameters while adding new data parameters and/or increasing and/or modifying some existing data parameters. The new detection directives are specialized for the detected incident pattern and are used to dynamically update the appropriate sensors. When no incident pattern is detected, it may be too costly and resource intensive to collect all the required data for every possible incident. This adaptive approach allows the monitoring system to precisely identify incidents while efficiently utilizing available resources without being restricted to detecting only a limited number of different incident patterns.

In some embodiments, additional sensors are deployed and/or activated. For example, additional software-based sensors can be deployed at targeted locations to collect additional data parameters required to confirm the detected incident. The additional sensors may only be active for confirming specific incidents. For example, they may be activated only for particular detected incident patterns.

At 207, data from updated sensors is received and analyzed. Once the appropriate sensor devices have been updated, revised data parameters are collected and received. The data received is specific for the incident pattern detected at 203 and is analyzed to verify the detected incident. In some embodiments, the incident is verified by applying a machine learning model using the revised data parameters. The newly collected data from the updated sensors allows the adaptive and dynamic monitoring platform to accurately confirm the existence of the incident. Without the revised data parameters, a confirmation of the incident pattern would not be possible or can only be predicted with a much lower level of confidence.

At 209, a determination is made whether additional analysis performed at 207 confirms the detection of an incident based on the incident pattern detected at 203. In the event the incident is verified, processing continues to step 211. In the event the incident is not verified, processing continues to step 213.

At 211, a responsive action is performed. In response to confirming the incident, a responsive action is taken to mitigate the incident. For example, in the event a security attack is detected, network interfaces and accounts can be disabled, revoked, and/or modified and additional security requirements, such as additional authentication requirements and/or automatically enabling security responses based on a geographic location associated with the security violation, can be temporarily enforced. In some embodiments, certain user privileges and/or functionality may be disabled or limited until the detected threat incident is resolved. As another example, a detected incident can identify a pending hardware failure such as a soon-to-fail hard drive. The responsive action performed can include automatically scheduling the preventative maintenance or a physical replacement of the failing component and migrating the impacted data to a new location. Since the failure can be predicted to occur in the near but not immediate future, there can be a window of time for scheduling a replacement that allows the system to continue running with limited impact to users when the replacement is performed. In some embodiments, a responsive action is performed upon verification of a pending software failure. For example, a software process associated with the pending software failure can be automatically reconfigured, restarted, and/or reset.

At 213, detection directives are updated for sensors. In various embodiments, the detection directives are again updated for the sensor devices. For example, in the event an incident is confirmed to not exist, the detection directives may be reverted to their original settings. As another example, in the event an incident is confirmed or has been resolved, the detection directives may also be reverted to their original settings or may be modified to preemptively detect incidents related to the detected incident. For example, in some scenarios, a pending drive failure is often associated with a subsequent failed memory module. In the event a pending drive failure incident is confirmed, the detection directives for sensors can be updated with additional data parameters to more quickly identify the pending memory module failure incident.

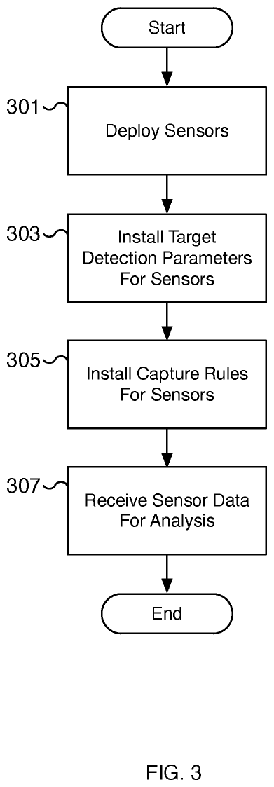

FIG. 3 is a flow chart illustrating an embodiment of a process for collecting sensor device data for automatically identifying incidents. Using the process of FIG. 3, sensor devices are deployed in an information technology infrastructure environment for detecting incidents such as events or vulnerabilities that can impact the performance, security, and health of the information technology environment. In various embodiments, the data is collected by software and/or hardware sensor devices that collect data parameter metrics based on configured detection directives. As the environmental conditions change, the sensors can be individually or collectively reconfigured to dynamically modify their detection goals. This process allows the monitoring platform to dynamically adapt to detected incident patterns and to collect only the data required for verifying detected incidents. In some embodiments, the process of FIG. 3 is performed at 201 of FIG. 2 as part of the process of collecting data for analysis to identify an incident pattern. In some embodiments, the process of FIG. 3 is also performed at 205 of FIG. 2 to update the detection directives for sensors based on an identified incident pattern. In some embodiments, the process of FIG. 3 is performed by an adaptive and dynamic monitoring platform such as the monitoring system of network services platform 111 of FIG. 1. In various embodiments, the sensor devices used to collect data parameters include sensor devices such as sensor 103 and sensors 113 of FIG. 1.

At 301, sensor devices are deployed. For example, sensor devices that are hardware and/or software based are deployed to collect data parameters of an information technology infrastructure system. In some embodiments, the sensor devices are implemented via software monitoring processes. For example, a software monitoring process can access functionality for measuring and monitoring CPU temperatures, memory access, I/O access, and network utilization, among other parameters. As another example, a sensor device can scan logs, such as message logs, generated by server daemons and/or operating system processes to collect data parameters. In some embodiments, the deployed sensor devices are deployed software processes that are launched to run on existing components such as a cloud server, a node server, a database server, or a remote client of the information technology infrastructure. In some embodiments, the sensor devices include hardware-based devices such as network analyzers for intercepting and monitoring traffic that passes over a network.

At 303, target detection parameters are installed for sensors. For each applicable sensor device, target detection parameters are installed that describe the data parameters to collect. For example, a group of sensor devices can be tasked to monitor and collect I/O operations. Another group of sensor devices can be tasked to monitor and collect database connections. High level application events can be monitored as well. For example, a sensor device can monitor and collect user login events and data sharing events. In various embodiments, the target detection parameters installed for a sensor are used to configure the data parameters that the sensor should target for collection.

In some embodiments, the sensor devices capture some randomly identified parameters for additional analysis. For example, additional data parameters randomly selected and/or a random sampling of selected data is collected and can be utilized for analysis. The additional random data allows the monitoring system to determine whether the randomly identified data or different collection schedules impact the analysis. For example, the additional data may increase the accuracy of prediction models. In the event the data is not shown to be helpful, their collection can be reduced, and the collection of other different and randomly selected data parameters can be increased. For example, randomly selected data parameters can be evaluated for their impact for a configured threshold period of time to determine whether the selected values increase the accuracy of the detection of a particular incident pattern type. In the event they do not increase the detection accuracy by a specified confidence threshold value, the sensor detection directives are modified. For example, the sensor detection directives can be modified by reducing the frequency the random data parameters are collected and/or by selecting and/or increasing the frequency of collection for different randomly selected data parameters.

At 305, capture rules are installed for sensors. In some embodiments, each sensor can be configured with capture rules. The capture rules are used to enable or disable data parameter collection based on configured conditions. For example, a capture rule can be configured to collect data parameters only for connections originating from outside a particular network or set of IP addresses. As another example, a capture rule can be configured to collect I/O access operations only when memory utilization exceeds a specified threshold value. In various embodiments, the capture rules can be configured by utilizing a set of capture rule keywords that correspond to certain operations such as logic and test operations. In some embodiments, the capture rules are designed to utilize minimal resource requirements and can be quickly evaluated especially in comparison to the analysis performed on the captured data to identify an incident pattern or verify an incident.

At 307, sensor data is received for analysis. For example, the data associated with the specified detection directives installed at 303 and/or 305 are received by an analysis component of the adaptive and dynamic monitoring platform. In some embodiments, the analysis component is a specialized software process running on a computer processing server such as a cloud server. The analysis component of the monitoring platform is configured to receive the collected data for future analysis. In some embodiments, the analysis component is distributed across multiple compute engines and can include one or more data stores. For example, the data collected by the sensors deployed at 301 can be received at a data store, where it can be later accessed for pre-processing, aggregation, and/or further analysis.

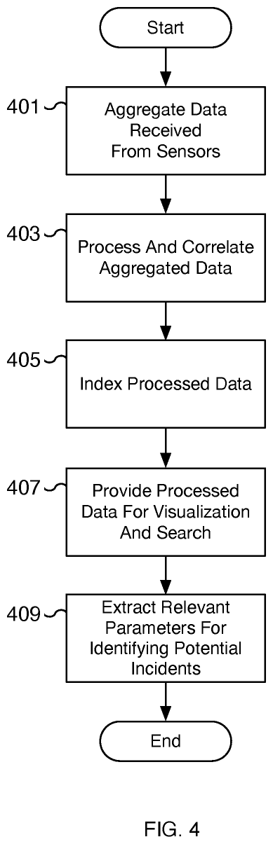

FIG. 4 is a flow chart illustrating an embodiment of a process for analyzing collected sensor device data. Using the process of FIG. 4, sensor devices are deployed in an information technology infrastructure environment for collecting data parameters associated with the information technology environment. The collected data is then analyzed to extract parameters for detecting incidents and in particular by first detecting an incident pattern as an indicator of an incident. Once an incident pattern is detected, additional and more fine-tuned data collection and analysis can be performed to verify the detected incident. In some embodiments, the process of FIG. 4 is performed at 201 and/or 203 of FIG. 2 as part of the process of analyzing collected sensor data to determine incident patterns. In some embodiments, the process of FIG. 4 is performed by an adaptive and dynamic monitoring platform such as the monitoring system of network services platform 111 of FIG. 1. In various embodiments, the sensor devices used to collect data parameters include sensor devices such as sensor 103 and sensors 113 of FIG. 1.

At 401, data received from sensor devices is aggregated. For example, data is received from a multitude of distributed sensor devices. The data received can be formatted differently depending on the collected data. At 401, the various data are aggregated together for future processing.

At 403, the aggregated data is processed and correlated. For example, data from different sensors of the same network connection are processed and correlated. By matching data from different sensors to their related activities, the value of the cumulative data is significantly improved. For example, an end-to-end perspective can be obtained by correlating different data sets received from different sensors. In some embodiments, the correlation is in part performed by synchronizing time stamps and data collection identifiers such as device, user, connection, and/or hardware identifiers.

At 405, the processed data is indexed. For example, the processed data is indexed in a manner to make the data more accessible for analysis. In some embodiments, the data is indexed to improve the ability to perform complex searches on the processed data. The indexing can be performed to support both manually performed searches, such as searches initiated by operators, as well as searches used to feed visualization functionality and/or management tools. For example, the data can be indexed to allow the processed results to be easily accessed by visualization tools.

At 407, the processed data is provided for visualization and search. For example, the processed data is made available for operators to access visually. In some embodiments, the processed data is accessible via a graphical user interface for visualizing the collected data. The processed data can further be searched, for example, by specifying search terms and/or utilizing search operators. For example, an operator accessing a graphical user interface of the processed data can search for all failed logins within a specified time window that originated from a specified geographic location and/or from a specific range of network addresses. Once the results are provided, the operator can further drill down to reveal additional details. In various embodiments, the operator can utilize an operator client such as operator client 105 of FIG. 1 for accessing the visualization and search functionality.

At 409, relevant data parameters for identifying potential incidents are extracted. In various embodiments, once the received sensor data is processed, relevant data parameters can be extracted and used as input features for identifying incident patterns. The incident patterns correspond to potential incidents that can be verified with additional monitoring and analysis. In various embodiments, the extracted data parameters are at least the minimal parameters required to identify incident patterns. The incident patterns can correspond to user behaviors, system behaviors, and hardware and/or software behaviors, among others. For example, data parameters associated with CPU, GPU, co-processor, memory, disk, input/output operations, operating system events, and hardware and/or software application events, among others, can be extracted for identifying potential incidents.

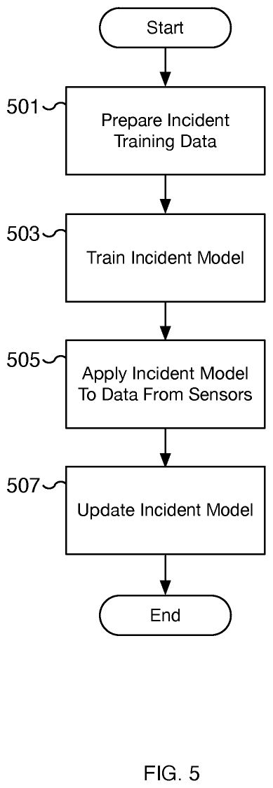

FIG. 5 is a flow chart illustrating an embodiment of a process for utilizing a machine learning incident model for identifying incidents. Using the process of FIG. 5, processed sensor data is used to train a machine learning model to identify incident patterns associated with incidents and/or to verify detected incidents. Example incidents include system, device, or component failures and errors as well as vulnerabilities such as security holes and attacks. In some embodiments, the process of FIG. 5 is performed at 203 of FIG. 2 and/or at 207 of FIG. 2. For example, a first set of incident models can be used to detect incident patterns and a second set of incident models can be used to verify incidents. In some embodiments, the process of FIG. 5 is performed by an adaptive and dynamic monitoring platform such as the monitoring system of network services platform 111 of FIG. 1. In various embodiments, the sensor devices used to collect data parameters include sensor devices such as sensor 103 and sensors 113 of FIG. 1.

At 501, incident training data is prepared. For example, data collected from sensors is processed into training data for training a machine learning model. The data collected may be first preprocessed, for example, by aggregating and correlating different data sets. The training data can be prepared from different data sets for generating separate models that can be used to identify incident patterns and verify detected incidents. Training data for additional models can be prepared as well. For example, training data can be prepared to identify relevant features for verifying incidents. In some embodiments, multiple models such as multiple pipelined models are required, and training data is appropriately processed. In various embodiments, the data preparation is performed based on identified incidents that should be detected. For example, data collected during a previously experienced incident can be used as a starting basis for preparing training data. In some embodiments, the training data is prepared from previously identified exploits, such as known security exploits. By leveraging researched and identified exploits, the range of detectable incidents is significantly increased.

At 503, an incident model is trained. Using the training data prepared at 501, a machine learning model is trained and verified. In some embodiments, the trained machine learning model may consist of multiple models that are connected and may utilize the output of one model as an input into another. In various embodiments, different models are trained for different parts of the incident detection process. For example, a model can be trained to identify incident patterns and a different model can be trained to verify detected incidents.

At 505, an incident model is applied to data collected from sensor devices. For example, an incident model trained at 503 is applied to infer prediction results such as an incident pattern or a confirmation of a detected incident. The input for the applied model includes at least sensor data collected from sensor devices distributed in the information technology environment. In various embodiments, the sensor data is first aggregated and processed before it can be utilized for machine learning prediction.

At 507, an incident model is updated. For example, the incident model is updated using more detailed and/or more recent or relevant collected data. As device components change such as the model, manufacturer, or version of a hard drive, processor, memory, operating system, firmware, or application process, the model is updated and revised to more accurately predict incidents. As another example, as new security threats are identified, an incident model can be updated and/or new models can be created to increase the functionality of existing models. In some embodiments, the updated model requires new detection directives for sensor devices. For example, the sensors are directed to capture additional and/or different data parameters to support the updated model.

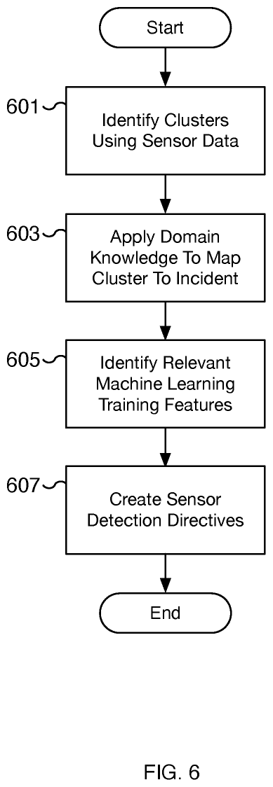

FIG. 6 is a flow chart illustrating an embodiment of a process for preparing a machine learning incident model for identifying incident patterns. Using the process of FIG. 6, processed sensor data is analyzed to identify relevant features associated with an incident or incident pattern. In some embodiments, sensor data is analyzed, for example, by using a clustering technique to identify relevant input features associated with an incident or incident pattern. The identified input features can then be utilized to train a machine learning incident model to identify associated incident patterns. In some embodiments, the process of FIG. 6 is performed in preparation for step 203 and/or step 207 of FIG. 2 and/or for steps 501 and/or 503 of FIG. 5. In some embodiments, the process of FIG. 6 is performed by an adaptive and dynamic monitoring platform such as the monitoring system of network services platform 111 of FIG. 1. In various embodiments, the sensor devices used to collect data parameters include sensor devices such as sensor 103 and sensors 113 of FIG. 1.

At 601, clusters are identified from sensor data. For example, the sensor data is analyzed using machine learning clustering techniques to determine related clusters. The clusters can be identified based on similarity and do not require supervised training. The clustering process can efficiently simplify the selection of data parameters for identifying a related incident.

At 603, domain knowledge is applied to map a cluster to an incident. Using the clusters identified at 601, one or more incidents are associated with the clusters. In some embodiments, the mapping of a cluster for use in predicting an incident or incident pattern requires domain knowledge. In various embodiments, an identified cluster of data parameters can be associated with an incident pattern such as a pending hardware failure, a security vulnerability, or another potential incident event. For example, a particular cluster or incident pattern can predict a hardware failure such as a hard disk drive, solid-state drive, memory, network interface, or processor failure, among others. Incident patterns can also predict software-based incidents such as a service task process that will become unresponsive or begin to start taking longer than expected to respond. As additional examples, user-based incidents can include predicted failed user logins or interrupted workflows such as dropped chat conversations or incomplete form submissions, among others. In some embodiments, an associated incident is identified by an operator with specific domain knowledge of the relationship between data parameters and incidents. In addition to domain knowledge, a source of potential incidents and their related factors can be imported from an existing database of incidents such as known security threats.

At 605, relevant machine learning training features are identified. Using the mapping determined at 603, relevant data parameters can be extracted from a cluster for training a machine learning model. For example, the extracted parameters can be utilized as machine learning training features. In some embodiments, a cluster of data parameters may be overinclusive and extracting only the most relevant parameters yields a highly accurate prediction without additional resources required for processing less relevant data parameters.

At 607, sensor detection directives are created. Using the relevant machine learning training features identified at 605, sensor detection directives are created. The sensor detection directives instruct the relevant sensor to capture and collect the required data needed for a machine learning prediction. In some embodiments, different sensor detection directives are created for different sensors. For example, a CPU sensor, an I/O sensor, and a service task sensor each capture different data parameters and are each provided with different detection directives. Moreover, not only do the different sensors capture different data parameters, the time and frequency of their monitoring may differ as well. In some embodiments, the created detection directives include the ability to spawn sensor software processes that are configured to capture the required data parameters.

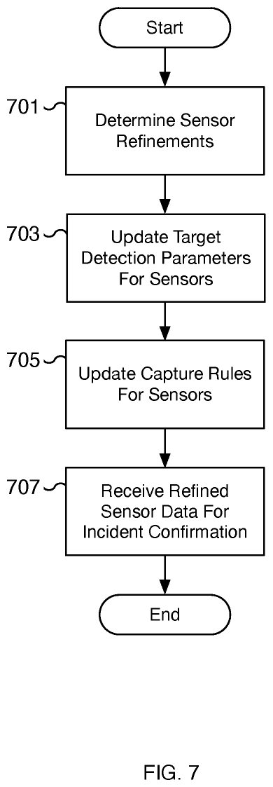

FIG. 7 is a flow chart illustrating an embodiment of a process for adapting sensor data collection for automatically identifying incidents. Using the process of FIG. 7, an information technology infrastructure system with a detected incident pattern is further analyzed to verify the detected incident. Essential data parameters required for verifying the incident are collected by dynamically adjusting the appropriate sensor devices. In some embodiments, non-essential data collection is paused to optimize performance and resource utilization. In some embodiments, the process of FIG. 7 is performed at 205 and/or 207 of FIG. 2. In some embodiments, the process of FIG. 7 is performed by an adaptive and dynamic monitoring platform such as the monitoring system of network services platform 111 of FIG. 1 to update detection directives for sensors such as sensor 103 and sensors 113 of FIG. 1.

At 701, sensor refinements are determined. For example, the monitoring and collection of data parameters by sensor devices can be dynamically adjusted in response to the detection of a potential incident such as an incident pattern. In various embodiments, additional data parameters may require monitoring and the monitoring of some previously monitored data parameters can be paused or stopped. Moreover, the frequency, scheduling, and conditions of the monitoring can be revised. The sensor refinements can include the creation of new detection directives that specify revised sets of data parameters to collect and how to collect them. For example, the sensor refinements may specify different log messages to scan and collect, or a different granularity for monitoring I/O access or processor temperature. In various embodiments, the refinements allow the monitoring platform to verify an incident that a previous analysis determines may be likely. In some embodiments, additional sensors are deployed and/or activated as part of the determined sensor refinements. For example, additional task process sensors can be deployed via the network to capture additional data parameters.

In some embodiments, the sensor refinements are determined by identifying one or more non-essential data parameters actively being collected and disabling the collection of the non-essential data parameters. By disabling the non-essential data parameters, the analysis can significantly reduce the amount of sensor data that needs to be collected and processed. The additional resources such as computational and network resources can be directed at collecting and analyzing additional essential data parameters.

At 703, target detection parameters are updated for sensors. For example, the refinements determined at 701 are used to update the data parameters collected by the sensor devices. For example, a service task process sensor may be updated to additionally collect data parameters related to file system access operations along with existing collected data parameters related to memory and CPU usage while also pausing the collection of energy consumption metrics. In some embodiments, the target detection parameters are installed as a part of a revised detection directive. Since sensors can be application specific, each sensor device can be updated with a customized set of target detection parameters.

At 705, capture rules are updated for sensors. For example, the refinements determined at 701 are used to update the capture rules used by the sensor devices for collecting data parameters. For example, a service task process sensor may be updated to only initiate the additional collection of file system access operations when a user account token is associated with a particular geographic location. As another example, a capture rule can specify that the frequency of the collection of CPU temperatures is increased only when the running average of the temperature of a single core of the CPU exceeds a specified threshold or when I/O operations attempt to access specified file locations. In various embodiments, the capture rules can be installed as a part of a revised detection directive. Since sensors can be application specific, each sensor device can be updated with a customized set of capture rules.

At 707, refined sensor data is received for confirming an incident. Using the applied sensor detection directives, the distributed sensor devices monitor and collect a revised set of data parameters. The collected data is received, for example, by an analysis component of the adaptive and dynamic monitoring platform. The analysis component may be a specialized software and/or hardware process running on a computer processing server such as a cloud server that is part of the monitoring platform. Once received, the refined sensor data can be utilized for confirming an incident. For example, the additional data can verify the existence of an incident initially detected by an incident pattern. In some embodiments, the refined sensor data is analyzed by applying machine learning to confirm the associated incident.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving via a network, collected data of a first set of parameters from one or more devices;
using machine learning to analyze at least a portion of the collected data of the first set of parameters to automatically identify one or more additional data parameters to be obtained to verify a detection of an incident pattern;
indicating the one or more additional data parameters to be obtained to at least a portion of the one or more devices;
receiving collected data responsive to the indicated one or more additional data parameters; and
based at least in part on the responsive collected data, verifying the detection of the incident pattern and performing a responsive action.

2. The method of claim 1, wherein the incident pattern is associated with a predictive indicator of a pending hardware failure.

3. The method of claim 2, wherein performing the responsive action includes scheduling a preventative maintenance action to replace an identified hardware device associated with the pending hardware failure.

4. The method of claim 1, wherein the incident pattern is associated with a predictive indicator of a pending software failure.

5. The method of claim 4, wherein performing the responsive action includes automatically reconfiguring a software process associated with the pending software failure.

6. The method of claim 1, wherein the incident pattern is associated with a predictive indicator of a security violation.

7. The method of claim 6, wherein performing the responsive action includes automatically enabling security responses based on a geographic location associated with the security violation.

8. The method of claim 1, further comprising:
identifying one or more non-essential data parameters of the first set of parameters; and
disabling the one or more non-essential data parameters from the one or more devices.

9. The method of claim 1, further comprising:
deploying one or more additional devices for collecting at least a portion of the one or more additional data parameters.

10. The method of claim 1, wherein the collected data includes at least one or more randomly selected data parameters.

11. The method of claim 10, further comprising:
determining after a threshold period of time that the one or more randomly selected data parameters do not increase accuracy of detection of an incident pattern type by a specified confidence threshold value; and
reducing a frequency of collecting the one or more randomly selected data parameters.

12. The method of claim 11, further comprising:
increasing a frequency of collecting one or more different randomly selected data parameters.

13. The method of claim 1, further comprising:
providing one or more capture rules to the one or more devices, wherein the one or more capture rules are associated with the one or more additional data parameters.

14. A system, comprising:
one or more processors; and
a memory coupled to the one or more processors, wherein the memory is configured to provide the one or more processors with instructions which when executed cause the one or more processors to:
receive via a network, collected data of a first set of parameters from one or more devices;
analyze using machine learning at least a portion of the collected data of the first set of parameters to automatically identify one or more additional data parameters to be obtained to verify a detection of an incident pattern;
indicate the one or more additional data parameters to be obtained to at least a portion of the one or more devices;
receive collected data responsive to the indicated one or more additional data parameters; and
based at least in part on the responsive collected data, verify the detection of the incident pattern and perform a responsive action.

15. The system of claim 14, wherein the incident pattern is associated with a predictive indicator of a pending hardware failure, and wherein the responsive action includes scheduling a preventative maintenance action to replace an identified hardware device associated with the pending hardware failure.

16. The system of claim 14, wherein the incident pattern is associated with a predictive indicator of a pending software failure, and wherein the responsive action includes automatically reconfiguring a software process associated with the pending software failure.

17. The system of claim 14, wherein the incident pattern is associated with a predictive indicator of a security violation, and wherein the responsive action includes automatically enabling security responses based on a geographic location associated with the security violation.

18. The system of claim 14, wherein the memory is further configured to provide the one or more processors with instructions which when executed cause the one or more processors to:
identify one or more non-essential data parameters of the first set of parameters; and
disable the one or more non-essential data parameters from the one or more devices.

19. The system of claim 14, wherein the memory is further configured to provide the one or more processors with instructions which when executed cause the one or more processors to:
provide one or more capture rules to the one or more devices, wherein the one or more capture rules are associated with the one or more additional data parameters.

20. A computer program product, the computer program product being embodied in a non-transitory computer readable storage medium and comprising computer instructions for:
receiving via a network, collected data of a first set of parameters from one or more devices;
using machine learning to analyze at least a portion of the collected data of the first set of parameters to automatically identify one or more additional data parameters to be obtained to verify a detection of an incident pattern;
indicating the one or more additional data parameters to be obtained to at least a portion of the one or more devices;
receiving collected data responsive to the indicated one or more additional data parameters; and
based at least in part on the responsive collected data, verifying the detection of the incident pattern and performing a responsive action.
